(19) United States
(12) Patent Application Publication
(10) Pub. No.: US 2010/0148531 A1
(43) Pub. Date: Jun. 17, 2010

(54) AUTOMOTIVE GLOVE BOX HINGE MECHANISM

(76) Inventors: Gregg S. Evans, Windsor (CA); Daniel W. Davie, Kalamazoo, MI (US); Richard Rhyshek, Belleville, MI (US); Brian Przysiecki, Howell, MI (US); Paul Fralick, Walled Lake, MI (US); Waine Rouse, Canton, MI (US)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 12/557,002

(22) Filed: Sep. 10, 2009

Related U.S. Application Data
(60) Provisional application No. 61/096,390, filed on Sep. 12, 2008.

(51) Int. Cl. B60R 7/06; E05D 11/00; E05B 15/02

(52) U.S. Cl. 296/37.12; 16/277; 292/340

(57) ABSTRACT

A glove box hinge mechanism may include a plurality of linkages pivotally attaching a glove box to a vehicle dashboard structure. The linkages may be configured to pivot and translate the glove box upwards and outwards, limiting downward travel of the glove box. At least one torque tube may extend between the plurality of linkages to coordinate movement of the linkages. The torque tube may rotate with the plurality of linkages. A striker may be affixed to the torque tube so that the striker rotates towards a latch when the glove box is closed and so that the striker rotates to provide unobstructed access to the glove box in the open position.

### CROSS-REFERENCE TO RELATED APPLICATION(S)

This application claims the benefit of provisional patent application U.S. Ser. No. 61/096,390, filed Sep. 12, 2008, which is expressly incorporated herein by reference.

### BACKGROUND OF INVENTION

a. Field of Invention

The invention relates generally to automotive storage units, and, more particularly, to a mechanism for an automotive glove compartment.

b. Description of Related Art

Automobile manufacturers have implemented a variety of glove boxes for storing items in passenger compartments. One line of glove boxes features a pivot located near the base of the glove box. When a passenger unlatches the glove box to access its contents, the glove box rotates outwards about the pivot. While this line of glove boxes is simple and lightweight, there are numerous associated drawbacks. First, when opened by a front seat passenger, the front closure of the glove box pivots downwards, generally towards the knees, shins, and/or lower extremities of a front seat passenger. If the front passenger does not exercise full care when opening the glove box, the front closure can strike the knees of the passenger. This line of glove boxes also is disadvantageous to front passengers by requiring them to lean considerably forward when attempting to replace or retrieve an item from the glove box.

Another form of glove box design implements at least one pin disposed along one or more lateral sides or edges of the glove box. Such pins generally work in conjunction with a track or stopping device to limit the range of rotation experienced by the glove box. Often these glove boxes initially open to a first, intermediate position. The pin temporarily restricts further movement of the glove box by moving to a first, intermediate position along the track. A passenger may then choose to manipulate the glove box to further pivot it to a second, fully-open position. While this type of design helps to prevent the glove box from striking the knees of the front passenger, the passenger must still use full care when opening the glove box to the second, fully-open position. Further, having to complete two distinct motions to fully open the glove box is inconvenient. This design also requires a passenger to lean considerably forward when attempting to replace or retrieve an item from the glove box.

A third line of glove boxes features hybrid designs. Some of these designs continue to involve glove boxes that open downwardly. Other designs similarly attempt to solve this passenger intrusion problem, yet involve elaborate designs having excessive components that add weight, cost, and also complexity that increases the opportunity for malfunction.

Accordingly, there remains a need for a glove box that appears aesthetically pleasing and provides advantages over known glove boxes.

### SUMMARY OF INVENTION

A glove box hinge mechanism is provided and may include a vehicle dashboard structure, a striker, a glove box with a plurality of sides, a front closure member, a latch, and a plurality of rotatable linkages. The vehicle dashboard structure may have an opening where the glove box may be disposed, and the striker may be disposed along a portion of the opening in the vehicle dashboard structure. The glove box may retain stowables in a closed position and provide access to stowables in an open position. The front closure member may form one of the sides of the glove box and may be integral with the vehicle dashboard structure when the glove box is in the dosed position. The latch may be provided along the front closure member or the glove box for selective engagement with the striker to retain the glove box in the closed position. The rotatable linkages may pivotally attach the glove box to the vehicle dashboard structure, and may rotate and translate the glove box and front closure member outward and upward towards the open position when the latch releases the striker. This motion can help limit the downward travel of the glove box and the front closure member. One possible approach to achieve this combined translational and rotational movement is to make some of the plurality of rotatable linkages longer than others. This may cause the glove box and front closure member to become more horizontal as the glove box translates outward and upward.

The glove box hinge mechanism may further include at least one torque tube disposed along the opening of the vehicle dashboard structure. The torque tube may extend between, affix to, and rotate with at least two of the rotatable linkages. The torque tube may help coordinate movement between at least two of the rotatable linkages. The torque tube may define the portion of the opening that the striker is affixed to and rotates with, and the striker may be rotated towards and away from the glove box. When the glove box approaches a closed position, the torque tube may rotate the striker to engage with the latch disposed on the front closure member. When a passenger opens the glove box, the torque tube may rotate the striker away from the glove box to provide unobstructed access to stowables in the glove box.

The glove box hinge mechanism may further include an extension spring attached to one of the plurality of rotatable linkages and the vehicle dashboard structure. The extension spring may act on one of the plurality of rotatable linkages to articulate the glove box towards and maintain the glove box in the open position. The extension spring may also provide a closing force that a passenger must overcome to articulate the glove box from the open position to the closed position.

The glove box hinge mechanism may further include a stopping mechanism or mechanisms along the glove box. The stopping mechanisms may contact the torque tube to stop rotation when the glove box approaches the open position. A release button may also be disposed along the glove box or the front closure member. To open the glove box from the closed position, a passenger triggers the release button that may be configured to release the striker from the latch.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and, together with the detailed description, serve to explain the principles of the invention. In the drawings:

FIG. 1A is a side view of a prior art glove box shown in a closed position;

FIG. 1B is a side view of the prior art glove box of FIG. 1A shown in an open position;

FIG. 2 is a perspective view of a glove box hinge mechanism according to the invention shown without an adjacent instrument panel or vehicle dashboard structure;

FIG. 3 is a perspective view of a glove box hinge mechanism showing components otherwise obscured by a glove box in hidden;

FIGS. 4A-4E are side views of the glove box hinge mechanism of FIG. 3 showing a sequence in which the hinge mechanism may open to allow access;

FIG. 5 is a side view of the glove box hinge mechanism of FIG. 3 in an open position and an opened front closure from representative prior art transposed for comparison; and

FIG. 6 is a perspective view of the glove box hinge mechanism of FIG. 3 having a protrusion and a spring that may assist in opening the hinge mechanism and maintaining the hinge mechanism in an open position.

### DETAILED DESCRIPTION OF THE PREFERRED EMBODIMENT

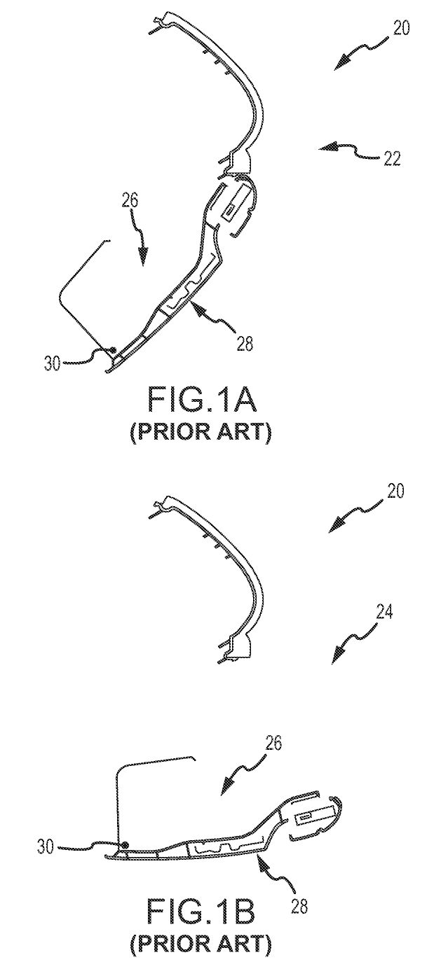

Referring now to the drawings wherein like reference numerals designate corresponding parts throughout the several views, FIGS. 1A and 1B illustrate a conventional prior art glove box 20. Prior art glove box 20 is shown in a closed position 22 in FIG. 1A and in an open position 24 in FIG. 1B. Prior art glove box 20 generally has a storage compartment 26 with a door 28. When opened for access, storage compartment 26 rotates about a pivot 30. As described earlier, this motion can cause door 28 to strike the knees of a passenger. Further, when prior art glove box 20 is fully opened, storage compartment 26 remains distant from the passenger, requiring the passenger to lean considerably forward to reach the contents of storage compartment 26.

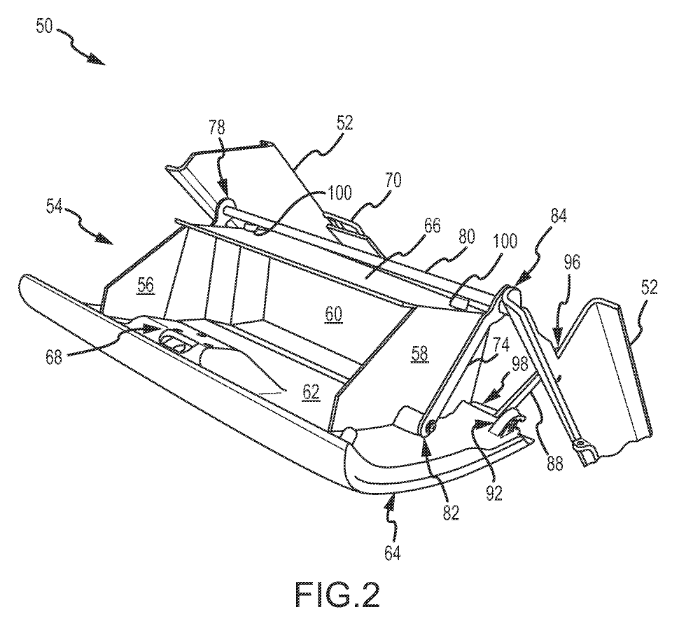

Now referring to FIGS. 2-6, various embodiments of a glove box hinge mechanism, generally designated “glove box hinge mechanism” 50, are disclosed. Referring to FIGS. 2, 3 and 6, glove box hinge mechanism 50 is shown generally attached to a frame 52 for illustrative purposes only. Frame 52 may represent portions of a vehicle dashboard structure.

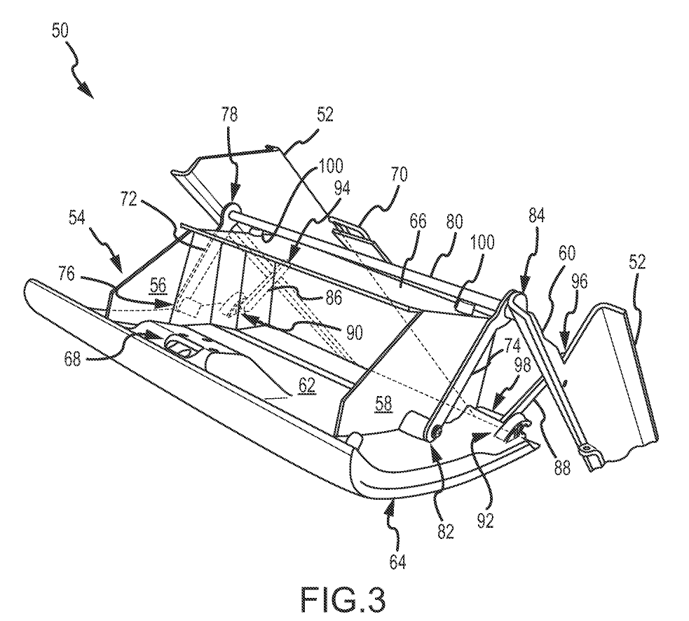

Referring to FIGS. 2 and 3, glove box hinge mechanism 50 may have a glove box 54 defined by a first sidewall 56, a second sidewall 58, a bottom 60, an inside surface 62 of a front closure member 64, and a back wall 66. Glove box 54 may retain various articles that a passenger wishes to stow. To selectively conceal glove box 54 when glove box hinge mechanism 50 is in a closed position, glove box hinge mechanism 50 may further include front closure member 64. To retain glove box hinge mechanism 50 in a dosed position, a latch 68 may be disposed along inside surface 62 of front closure member 64. When glove box hinge mechanism 50 is closed, latch 68 may engage a striker 70 to retain front closure member 64 and to conceal glove box 54.

Referring to FIGS. 2 and 3, glove box hinge mechanism 50 may include a first and second upper linkages 72, 74. First upper linkage 72 may pivotally attach to glove box 54 at a pivot 76 disposed alongside first sidewall 56. First upper linkage 72 may also attach at a joint 78 to a torque tube 80 supporting striker 70. Likewise, second upper linkage 74 may pivotally attach to glove box 54 at a pivot 82 disposed alongside second sidewall 58. Second upper linkage 74 may also attach to torque tube 80 at a joint 84. Torque tube 80 may help coordinate movement of both upper linkages 72, 74 when glove box 54 and front closure member 64 articulate. Torque tube 80 may pivotally attach to frame 52 or other vehicle structures such that it is free to rotate. In one embodiment, torque tube 80 may be affixed to upper linkages 72, 74 such that it rotates with upper linkages 72, 74.

Glove box hinge mechanism 50 may further include a first and second lower linkages 86, 88. First lower linkage 86 may pivotally attach to front closure member 64 at a pivot 90. Likewise, second lower linkage 88 may pivotally attach to front closure member 64 at a pivot 92. Though first and second lower linkages 86, 88 are shown pivotally attached to frame 52 at pivots 94, 96 respectively, in practice, a number of vehicle structures could support torque tube 80, lower linkages 86, 88, and glove box hinge mechanism 50 in general. In one embodiment, upper linkages 72, 74 may be substantially parallel, and lower linkages 86, 88 may be substantially parallel. Linkages 72, 74, 86, and 88 may be oriented outside glove box 54 such that they are hidden from the view of passengers. Pivots 90, 92 may be disposed in a variety of places, such as inside surface 62, a lower end 98 of front closure member 64, or an edge of glove box 54. Though operation of glove box hinge mechanism 50 is described below, to stop front closure member 64 and glove box 54 from opening further once in an open position, stoppers 100 may be provided along the rear of back wall 66. Once glove box 54 is in the open position, stoppers 100 may contact torque tube 80 and prevent further rotation and translation.

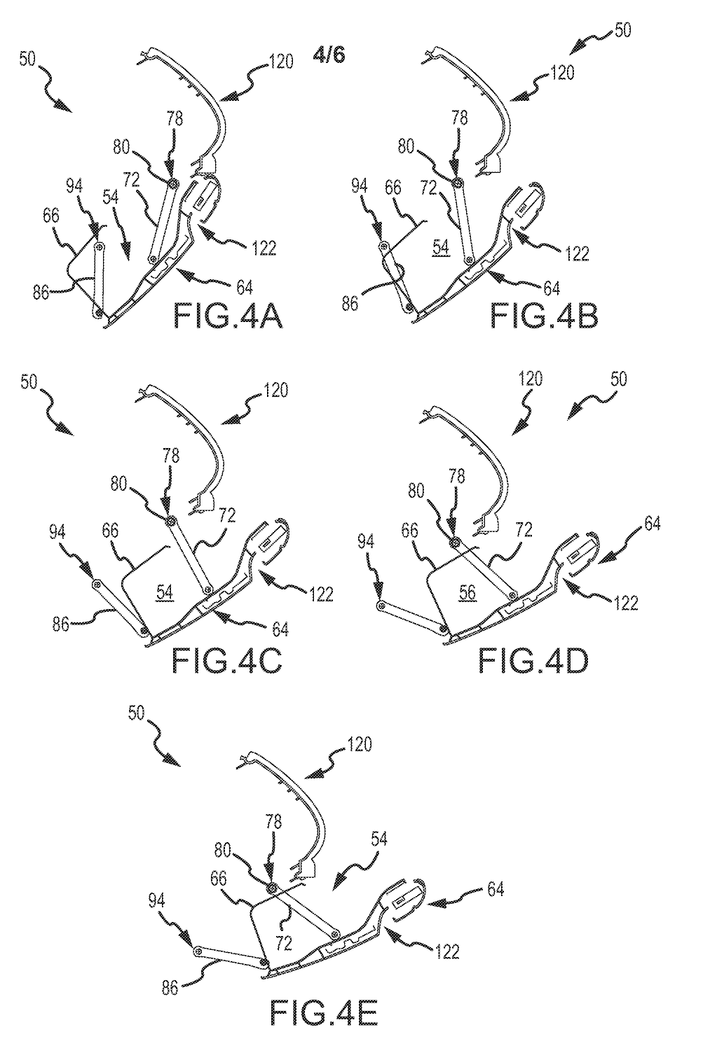

Next, FIGS. 4A-4E illustrate the articulation of glove box hinge mechanism 50. Specifically, as shown in FIG. 4A, glove box 54 and glove box hinge mechanism 50 are shown in a closed position. When closed, front closure member 64 may be integral with a dashboard 120. In this closed position, front closure member 64 conceals the contents of glove box 54 as latch 68 (shown in FIG. 3) retains striker 70 (shown in FIG. 3). As a passenger presses or engages a release button 122, latch 68 may release striker 70 causing front closure member 64 to separate from its integral position with dashboard 120.

As shown in FIG. 4B, first upper linkage 72 and first lower linkage 86 may start to rotate counterclockwise about joint 78 and pivot 94 respectively. Meanwhile, glove box 54 and front closure member 64 may start to rotate clockwise, causing front closure member 64 to become more horizontal. From the side, second upper linkage 74 and second lower linkage 88 are hidden in FIGS. 4A-4E. As mentioned above though, second upper linkage 74 and second lower linkage 88 may rotate in coordination with first upper linkage 72 and first lower linkage 86. In one embodiment, first and second upper linkages 72, 74 may rotate with and about torque tube 80.

FIGS. 4C and 4D illustrate how linkages 72, 86 continue to translate glove box 54 generally outwards and upwards towards an open position shown in FIG. 4E. In addition to this translation, glove box 54 rotates clockwise about itself, becoming increasingly horizontal. Glove box 54 may be said to articulate when these rotational and translational motions are combined. To provide articulation, upper linkages 72, 74 may be longer than lower linkages 86, 88. As glove box 54 approaches the open position of FIG. 4E, stoppers 100 (shown in FIG. 3) on back wall 66 of glove box 54 may contact torque tube 80 to stop glove box 54 in the open position.

This outwards and upwards articulation of glove box 54 and front closure member 64, shown in FIGS. 4A-4E, as opposed to the movement of prior art glove boxes shown in FIGS. 1A and 1B, is beneficial for multiple reasons. First, additional knee clearance is provided for a front seat passenger, as glove boxes may be placed further away from a passenger if need be. Second, the passenger does not have to use caution when accessing glove box 54, since articulation of glove box 54 reduces the chance that front closure member 64 will strike the extremities of a passenger. Third, extra components causing glove box 54 to open in multiple stages are unnecessary. Fourth, glove box hinge mechanism 50 features a simple design without having elaborate components that add weight, complexity, and cost to the vehicle. Lastly, instead of opening outwards and downwards like various prior art designs, glove box 54 opens outwards and upwards. This articulation of glove box 54, shown in FIG. 4E, reduces the reach required to access items in glove box 54.

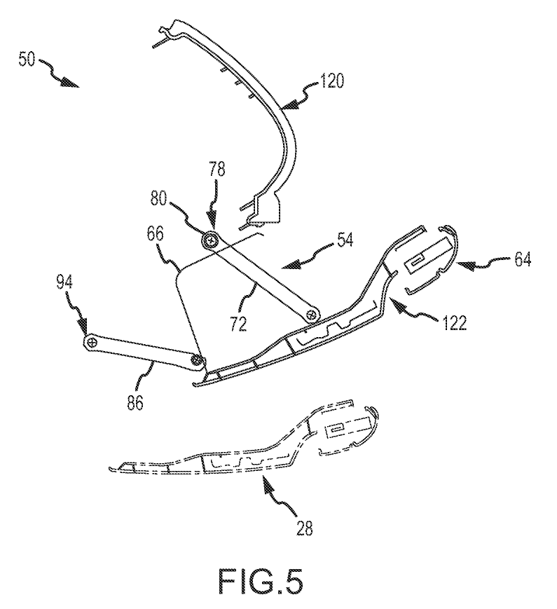

FIG. 5 transposes door 28 of the prior art shown in FIGS. 1A and 1B onto a side view of glove box 54 in the open position. Though the drawings may not be to scale, it can be seen that when both the prior art glove box and glove box hinge mechanism 50 are fully opened, glove box 54 and front closure member 64 appear much closer to a passenger than door 28 of the prior art. One skilled in the art would appreciate such articulation, especially in sports cars due to the reclined occupant position. More senior passengers might also appreciate such articulation because of the reduced need to lean forward to access the contents of glove box 54. From an aesthetics standpoint, glove box hinge mechanism 50 also provides desirable rotational and translational motion for front closure member 64, as opposed to the simple pivoting motion of conventional glove box doors.

Referring back to FIGS. 2 and 3, in one embodiment striker 70 may be affixed to torque tube 80 and rotate therewith. In another embodiment, striker 70 may be formed integral with torque tube 80 to rotate therewith. FIGS. 2 and 3 show glove box hinge mechanism 50 in an open position. As shown, striker 70 is positioned upwards, providing full, unobstructed access to glove box 54. When glove box 54 starts to close, torque tube 80 may rotate along with upper linkages 72, 74. Hence when glove box 54 starts to close, torque tube 80 may also rotate striker 70 downwards, towards glove box 54. As torque tube 80 rotates striker 70 towards glove box 54, latch 68 on front closure member 64 approaches striker 70. When front closure member 64 approaches a fully dosed position, striker 70 is positioned downwards for engagement with latch 68. Accordingly, front closure member 64 may become integral with dashboard 120 while latch 68 retains striker 70. Stated in the reverse, when front closure member 64 is opened and articulated outwards and upwards, torque tube 80 may rotate in the opposite direction, pivoting striker 70 upwards as shown in FIGS. 2 and 3.

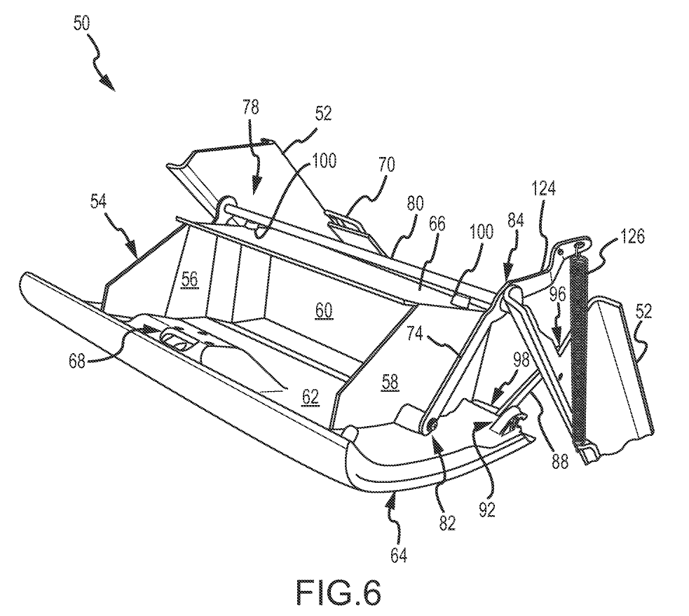

Now referring to FIG. 6, in one embodiment second upper linkage 74 may include a protrusion 124 extending beyond joint 84. Protrusion 124 may connect to a spring 126 that is attached to frame 52, or another vehicle structure. Spring 126 may be tensioned such that when a passenger engages release button 122 (shown in FIG. 4A), spring 126 pulls downwards on protrusion 124. This in turn causes second upper linkage 74, torque tube 80, and first upper linkage to rotate and thus articulate glove box 54 outwards and upwards. When glove box 54 is opened, spring 126 may still be in tension, maintaining glove box 54 in an open position until a passenger desires to close glove box 54 by overcoming the force spring 126 supplies. While protrusion 124 is shown extending from second upper linkage 74, the present disclosure contemplates other variants of articulating glove box 54. For example, protrusion 124 may extend from first upper linkage 72 and spring 126 may be located on the other side of glove box 54. In a further example, spring 126 may attach to other locations, such as linkages, front closure member 64, side walls 56, 58, and the like.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A glove box hinge mechanism usable with a vehicle dashboard structure having an opening, and a striker disposed along a portion of the opening, the mechanism comprising:
a glove box having a plurality of sides, the glove box disposable in the opening in the vehicle dashboard structure and including a closed position for retaining stowables and an open position for providing access to the stowables;
a front closure member defining one of the sides of the glove box and being generally integral with the vehicle dashboard structure when the glove box is attached to the vehicle dashboard structure and disposed in the closed position;
a latch disposed along the front closure member and selectively engageable with the striker to retain the glove box in the closed position;
a plurality of rotatable linkages for pivotally attaching the glove box to the vehicle dashboard structure, the plurality of rotatable linkages for pivoting and translating the glove box and the front closure member to limit downward travel of the glove box and the front closure member; and
at least one torque tube affixed between the plurality of rotatable linkages to coordinate movement of the plurality of rotatable linkages.

2. A glove box hinge mechanism according to claim 1, further comprising an extension spring attached to one of the rotatable linkages for articulating the glove box towards and maintaining the glove box in the open position.

3. A glove box hinge mechanism according to claim 2, wherein the extension spring provides a closing force that a passenger overcomes to articulate the glove box from the open position to the closed position.

4. A glove box hinge mechanism according to claim 1, wherein the torque tube defines the portion of the opening that the striker is affixed to and rotates with, the striker being rotated to engage with the latch when the glove box is in the closed position and rotated to provide unobstructed access to the glove box when the glove box is in the open position.

5. A glove box hinge mechanism according to claim 1, wherein the plurality of rotatable linkages vary in length such that the glove box articulates outwards and upwards when moving from the closed position to the open position.

6. A glove box hinge mechanism according to claim 1, further comprising a release button disposed on the front closure member and operatively connected to the latch to release the striker when triggered by a passenger.

7. A glove box hinge mechanism according to claim 1, wherein one of the plurality of sides of the glove box further includes a stopping assembly that contacts the torque tube and stops the glove box from further articulation when the glove box approaches the open position.

8. A glove box hinge mechanism usable with a vehicle dashboard structure having an opening, the mechanism comprising:
a glove box with a front closure member disposable in the opening in the vehicle dashboard and having a closed position for retaining stowables and an open position for providing access to the stowables;
at least two upper linkages pivotally attached at first ends thereof to the glove box and at second ends thereof to the vehicle dashboard structure;
at least two lower linkages pivotally attached at first ends thereof to the glove box and at second ends thereof to the vehicle dashboard structure; and
at least one torque tube affixed between the upper linkages to coordinate movement of the upper linkages, the torque tube supporting an integral striker that rotates with the upper linkages to provide clearance for the glove box;
wherein the upper and lower linkages are configured to pivot and translate the glove box and front closure member to limit downward travel of the glove box and the front closure member.

9. A glove box hinge mechanism according to claim 8, further comprising an extension spring attached to one of the linkages for articulating the glove box towards and maintaining the glove box in the open position.

10. A glove box hinge mechanism according to claim 9, wherein the extension spring provides a closing force that a passenger overcomes to articulate the glove box from the open position to the closed position.

11. A glove box hinge mechanism according to claim 8, wherein the integral striker is rotated to engage with a latch when the glove box is in the closed position, the integral striker being rotated to provide unobstructed access to the glove box when the glove box is in the open position.

12. A glove box hinge mechanism according to claim 8, wherein the upper linkages are of different length than the lower linkages so as to articulate the glove box outwards and upwards when moving from the closed position to the open position.

13. A glove box hinge mechanism according to claim 8, wherein the glove box further comprises a side having a stopping mechanism that contacts the torque tube and stops the glove box from further articulation when the glove box approaches the open position.

14. A glove box hinge mechanism usable with a vehicle dashboard structure having an opening, and a striker disposed along a portion of the opening, the mechanism comprising:
a glove box having a plurality of sides and disposable in the opening in the vehicle dashboard structure, the glove box having a closed position for retaining stowables and an open position for providing access to the stowables;
a front closure member defining one of the sides of the glove box and being integral with the vehicle dashboard structure when the glove box is in the closed position;
a latch disposed along the front closure member for selectively engaging the striker to retain the glove box in the closed position; and
a plurality of rotatable linkages pivotally attached to the vehicle dashboard structure and pivotally supporting the glove box, the linkages rotate and translate the glove box and front closure member outwards and upwards towards the open position when the latch releases the striker, and limit downward travel of the glove box and the front closure member.

15. A glove box hinge mechanism according to claim 14, further comprising at least one torque tube disposed along the opening of the vehicle dashboard structure and extending between and affixed to at least two of the plurality of rotatable linkages, wherein the torque tube coordinates movement between at least two of the plurality of rotatable linkages.

16. A glove box hinge mechanism according to claim 15, wherein the torque tube defines the portion of the opening that the striker is affixed to and rotates with, the striker being rotated to engage with the latch when the glove box is in the closed position and rotated to provide unobstructed access to the glove box when the glove box is in the open position.

17. A glove box hinge mechanism according to claim 14, further comprising an extension spring attached to one of the plurality of rotatable linkages and capable of articulating the glove box towards and maintaining the glove box in the open position.

18. A glove box hinge mechanism according to claim 17, wherein the extension spring provides a closing force that a passenger must overcome to articulate the glove box from the open position to the closed position.

19. A glove box hinge mechanism according to claim 14, wherein the plurality of rotatable linkages vary in length such that the glove box articulates outwards and upwards when moving from the closed position to the open position.

20. A glove box hinge mechanism according to claim 14, wherein one of the plurality of sides of the glove box further includes a stopping assembly that contacts the torque tube and stops the glove box from further articulation when the glove box approaches the open position.
